(19) United States
(12) Patent Application Publication
(10) Pub. No.: US 2026/0051128 A1
(43) Pub. Date: Feb. 19, 2026

(54) GUIDED IN-PAINTING

(71) Applicant: Varjo Technologies Oy, Helsinki (FI)

(72) Inventor: Mikko Ollila, Tampere (FI)

(73) Assignee: Varjo Technologies Oy, Helsinki (FI)

(21) Appl. No.: 18/804,626

(22) Filed: Aug. 14, 2024

(51) Int. Cl. G06T 19/00; G06F 3/01; G06T 15/40; G06V 10/82

(52) U.S. Cl. CPC G06T 19/006; G06F 3/012; G06F 3/013; G06T 15/40; G06V 10/82

(57) ABSTRACT

A computer-implemented method including: obtaining information indicative of a gaze direction of a user; determining a gaze region of a video-see-through image of real-world environment, based on the gaze direction of the user; determining an image segment in the VST image that lies at least partially within the gaze region; identifying object(s) at which the user is looking, based on the gaze direction of the user, and optionally at least one of: a camera pose from which the VST image is captured, a three-dimensional model of the real-world environment; and synthetically generating at least the image segment in the VST image, based on the object(s) at which the user is looking, by utilising neural network(s), wherein input(s) of the neural network(s) indicates the object(s).

### TECHNICAL FIELD

The present disclosure relates to computer-implemented methods incorporating guided in-painting. The present disclosure also relates to systems incorporating guided in-painting.

### BACKGROUND

Nowadays, with an increase in the number of images being captured every day, there is an increased demand for developments in image processing. Such a demand is quite high and critical in case of evolving technologies such as immersive extended-reality (XR) technologies which are being employed in various fields such as entertainment, real estate, training, medical imaging operations, simulators, navigation, and the like. Several advancements are being made to develop image processing technology.

As the captured images are extremely prone to introduction of various types of visual artifacts, for example, such as a blur, a noise, missing/obliterated visual information, or similar therein, such visual artifacts results in deterioration of an image quality of the captured images. Typically, such visual artifacts are introduced in the captured images due to various reasons, for example, such as variations in lighting conditions of a real-world environment being captured by a camera, a sudden movement of the camera that is capturing images, a sudden movement of an object being captured by the camera, a dis-occlusion of an object (or its portion) in an image upon reprojection, an autofocus blurring of a background or a foreground in the image, and the like. Thus, the captured images are generally not used, for example, to display to users directly or to create XR environments. Since the human visual system is very sensitive to detecting such visual artifacts, even in a case where said captured images are still displayed directly to a given user, the given user will easily notice a lack of sharpness, missing/obliterated visual information, a presence of noise, and the like, in said captured images. This leads to a highly unrealistic and non-immersive visual experience for the given user, making the captured images unsuitable for direct display purposes or for creating high-quality XR environments. Moreover, such visual artifacts also adversely affect image aesthetics, which is undesirable when creating the XR environments. Furthermore, existing image processing technology is not well-suited for generating defect-free images along with fulfilling other requirements in XR devices, for example, such as a high resolution (such as a resolution higher than or equal to 60 pixels per degree), a small pixel size, and a high frame rate (such as a frame rate higher than or equal to 90 FPS).

Some existing image processing technology employs a generic image inpainting method which is typically used to reconstruct a corrupted image only by utilising surrounding visual information. In contrast to this, a multi-modal inpainting method incorporates a text input which can be used to describe an object to be reconstructed, and a mask which can be used to constrain a shape of the object to be reconstructed. However, such a method often results in unintended modifications to a background texture surrounding the object being reconstructed. Moreover, actual implementation of such existing image processing technology requires considerable processing resources, involves a long processing time, requires a high computing power.

Therefore, in light of the foregoing discussion, there exists a need to overcome the aforementioned drawbacks.

### SUMMARY

The present disclosure seeks to provide a computer-implemented method and a system to produce high-quality video-see-through (VST) images, by way of synthetically generating at least an image segment of a VST image using at least one neural network, in a computationally-efficient and a time-efficient manner. The aim of the present disclosure is achieved by a computer-implemented method and a system which incorporate guided in-painting, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of an architecture of a system incorporating guided in-painting, in accordance with an embodiment of the present disclosure;

FIG. 2 illustrates steps of a method incorporating guided in-painting, in accordance with an embodiment of the present disclosure;

FIGS. 3A and 3B illustrates different exemplary scenarios of utilising at least one neural network for synthetically generating an image segment of a video-see-through (VST) image of a real-world environment, in accordance with different embodiments of the present disclosure;

FIG. 4A illustrates an exemplary video-see-through (VST) image of a real-world environment, FIG. 4B illustrates an exemplary reprojected VST image of the real-world environment, while FIG. 4C illustrates the reprojected VST image upon synthetically generating a region in the reprojected VST image, in accordance with an embodiment of the present disclosure; and

FIG. 5A illustrates an exemplary video-see-through (VST) image of a real-world environment, while FIG. 5B illustrates an exemplary previous image of the real-world environment that was displayed to a user, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a computer-implemented method comprising:
obtaining information indicative of a gaze direction;
determining a gaze region of a video-see-through (VST) image of a real-world environment, based on the gaze direction;
determining an image segment in the VST image that lies at least partially within the gaze region of the VST image;
identifying at least one object at which a user is looking, based on the gaze direction, and optionally at least one of: a camera pose from which the VST image is captured, a three-dimensional (3D) model of the real-world environment; and
synthetically generating at least the image segment in the VST image, based on the at least one object at which the user is looking, by utilising at least one neural network, wherein at least one input of the at least one neural network indicates the at least one object.

In a second aspect, an embodiment of the present disclosure provides a system comprising:

a data storage for storing at least one neural network; and
at least one processor configured to:
obtain information indicative of a gaze direction;
determine a gaze region of a video-see-through (VST) image of a real-world environment, based on the gaze direction;
determine an image segment in the VST image that lies at least partially within the gaze region of the VST image;
identify at least one object at which a user is looking, based on the gaze direction, and optionally at least one of: a camera pose from which the VST image is captured, a three-dimensional (3D) model of the real-world environment; and
synthetically generate at least the image segment in the VST image, based on the at least one object at which the user is looking, by utilising the at least one neural network, wherein at least one input of the at least one neural network indicates the at least one object.

The present disclosure provides the aforementioned computer-implemented method and the aforementioned system for producing high-quality video-see-through (VST) images, by way of synthetically generating at least the image segment of the VST image using the at least one neural network, in a computationally-efficient and a time-efficient manner. Herein, the image segment is determined in the VST image, wherein the image segment lies at least partially within the gaze region of the VST image. Once the at least one object that is represented in the gaze region is identified, the at least one neural network is utilised for synthetically generating at least the image segment in the VST image accordingly. Advantageously, in this manner, the at least one object at which the user is looking is highly accurately and realistically represented in the VST image. In other words, at least the gaze region in the VST image is free from any visual artifacts (for example, such as a blur, a noise, missing/obliterated visual information, or similar) which are likely introduced due to various reasons, for example, such as variations in lighting conditions of the real-world environment being captured by a camera, a sudden movement of the camera that is capturing VST images, a sudden movement of an object being captured by the camera, a dis-occlusion of an object (or its portion) in an image upon reprojection, an autofocus blurring of a background or a foreground in the VST image, and the like. Moreover, upon said synthetic generation, VST images could be conveniently used to create extended-reality (XR) environments. Such an approach not only conserves computational resources of the at least one processor, but also reduces an overall processing time of the at least one processor, without compromising on an image quality of the VST image upon said synthetic generation. The method and the system are susceptible to be employed for generating high visual quality images along with fulfilling other requirements in XR devices, for example, such as a high resolution (such as a resolution higher than or equal to 60 pixels per degree), a small pixel size, a large field of view, and a high frame rate (such as a frame rate higher than or equal to 90 FPS). The method and the system are simple, robust, fast, reliable, support real-time guided in-painting using the at least one neural network, and can be implemented with ease.

Notably, the at least one processor controls an overall operation of the system. The at least one processor is communicably coupled to at least the data storage. Optionally, the at least one processor is implemented as a processor of a computing device. Examples of the computing device include, but are not limited to, a laptop, a desktop, a tablet, a phablet, and a console. Alternatively, optionally, the at least one processor is implemented as a cloud server (namely, a remote server) that provides a cloud computing service. It will be appreciated that the data storage for storing the at least one neural network may be implemented as a memory of the system, a memory of the computing device, a removable memory, a cloud-based database, or similar.

Optionally, the at least one processor is configured to obtain, from a client device, the information indicative of the gaze direction. The client device could be implemented, for example, as a head-mounted display (HMD) device. The term “gaze direction” refers to a direction in which a given eye of a given user is gazing. In some implementations, the gaze direction may be a gaze direction of a single user of a client device. In other implementations, the gaze direction may be an average gaze direction for multiple users of different client devices (in a multi-user scenario). In yet other implementations, the gaze direction may be assumed to be always directed along a depth axis (namely, a Z-axis) of the VST image (i.e., directed straight towards a centre of the VST image). This is because a user's gaze is generally directed towards a centre of his/her field of view. The gaze direction may be represented by a gaze vector. The term “head-mounted display” device refers to specialized equipment that is configured to present an extended-reality (XR) environment to a user when said HMD device, in operation, is worn by the user on his/her head. The HMD device is implemented, for example, as an XR headset, a pair of XR glasses, and the like, that is operable to display a visual scene of the XR environment to the user. The term “extended-reality” encompasses augmented reality (AR), mixed reality (MR), and the like. In some implementations, the system is remotely located from the client device. In other implementations, the system is integrated into the client device.

It will be appreciated that in some cases, the client device comprises gaze-tracking means (namely, a gaze tracker) and a processor configured to determine the gaze direction of the user by utilising the gaze-tracking means. In such cases, the information indicative of the gaze direction could be obtained by processing gaze-tracking data that is collected by the gaze-tracking means. In other cases, the client device comprises pose-tracking means and a processor configured to determine the gaze direction of the user by utilising the pose-tracking means (namely, a pose tracker). In such cases, the client device may not comprise the gaze-tracking means. In such cases, the information indicative of the gaze direction could still be obtained, for example, by inferring the gaze direction using information indicative of a camera pose of a camera of the client device, wherein the camera is controlled to capture the VST image, and the camera pose is detected using the pose-tracking means. This is because the gaze region of the VST image could be identified as (namely, deemed to be) a region in the VST image that lies along a viewing direction of the camera pose. The term “pose” encompasses a viewing position and/or a viewing direction. In yet other cases, the client device comprises both the gaze-tracking means and the pose-tracking means. In such cases, the information indicative of the gaze direction could be obtained by processing the gaze-tracking data, and using the information indicative of the camera pose. The gaze-tracking data may comprise images/videos of the given eye of the given user, sensor values, or the like.

Hereinabove, the term “gaze-tracking means” refers to specialized equipment for detecting and/or following a gaze of the given eye of the given user. The gaze-tracking means could be implemented as at least one of:

(i) contact lenses with sensors (for example, such as a microelectromechanical systems (MEMS) accelerometer and a gyroscope employed to detect a movement and an orientation of a given eye, and/or electrodes employed to measure electrooculographic (EOG) signals generated by the movement of the given eye),
(ii) at least one infrared (IR) light source and at least one IR camera, wherein the at least one IR light source is employed to emit IR light towards the given eye, while the at least one IR camera is employed to determine a position of a pupil of the given eye with respect to at least one glint (formed due to a reflection of the IR light off an ocular surface of the given eye),
(iii) at least one camera, employed to determine a position of the pupil of the given eye with respect to corners of the given eye, and optionally, to determine a size and/or a shape of the pupil of the given eye,
(iv) a plurality of light field sensors employed to capture a wavefront of light reflected off the ocular surface of the given eye, wherein the wavefront is indicative of a geometry of a part of the ocular surface that reflected the light,
(v) a plurality of light sensors and optionally, a plurality of light emitters, wherein the plurality of light sensors are employed to sense an intensity of light that is incident upon these light sensors upon being reflected off the ocular surface of the given eye, and to determine a direction from which the light is incident upon these light sensors.

Such gaze-tracking means are well-known in the art. Furthermore, the term “pose-tracking means” refers to specialized equipment for detecting and/or following the camera pose of the camera. Optionally, the pose-tracking means is employed to track a pose of the HMD device that is worn by the given user on his/her head, when the camera is mounted on the HMD device. Thus, in such a case, the camera pose of the camera changes according to a change in the pose of the HMD device. The pose-tracking means could be implemented as at least one of: an optics-based tracking system (which utilises, for example, infrared beacons and detectors, infrared cameras, visible-light cameras, and the like), an accelerometer, a gyroscope, an Inertial Measurement Unit (IMU), a Timing and Inertial Measurement Unit (TIMU). The pose-tracking means are well-known in the art.

Optionally, the camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the camera is implemented as a depth camera. Examples of the depth camera include, but are not limited to, a Time-of-Flight (ToF) camera, a light detection and ranging (LiDAR) camera, a Red-Green-Blue-Depth (RGB-D) camera, a laser rangefinder, a stereo camera, a plenoptic camera, an infrared (IR) camera, a ranging camera, a Sound Navigation and Ranging (SONAR) camera. Optionally, the camera is implemented as a combination of the visible-light camera and the depth camera.

The VST image is a visual representation of the real-world environment. The term “visual representation” encompasses colour information represented in the VST image, and additionally optionally other attributes (for example, such as depth information, transparency information, luminance information, brightness information, and the like) associated with the VST image.

Optionally, when determining the gaze region of the VST image, the at least one processor is configured to map the gaze direction onto the VST image. The term “gaze region” refers to a region of the VST image where the gaze is directed. In other words, the gaze region is understood to be a gaze-contingent region (i.e., a region of interest) in the VST image at which the user is looking. Optionally, an angular extent of the gaze region lies in a range of 0 degree from a gaze position in the VST image to 2-50 degrees from said gaze position. Optionally, upon determining the gaze region, the at least one processor is configured to determine a peripheral region as a region in the photo-sensitive surface that surrounds the gaze region. The peripheral region may, for example, remain after excluding the gaze region from the VST image. Optionally, an angular width of the peripheral region lies in a range of 12.5-50 degrees from said gaze position to 45-110 degrees from said gaze position. In active foveation implementations, the gaze region in the VST image is identified in a dynamic manner, based on the gaze direction. In fixed-foveation implementations, the gaze region in the given input image is identified in a fixed manner, according to the centre of the VST image.

Throughout the present disclosure, the term “image segment” of the VST image refers to a portion (namely, a segment) of the VST image. A given image segment of the VST image may have any shape and/or size. Different image segments of the VST image may have different shapes and/or different sizes. The given image segment of the VST image may comprise a plurality of pixels.

Optionally, the at least one processor is configured to divide the VST image into a plurality of image segments. Such a division of the VST image could be performed, for example, by using at least one of: a colour analysis, a contrast analysis, a semantic analysis, an activity analysis. When the colour analysis is used, pixels of the VST image having same colour information may be identified and grouped together to form a given image segment. When the contrast analysis is used, the plurality of image segments may be determined by differentiating high-contrast areas from low-contrast areas in the VST image. When the semantic analysis is used, contextual information represented in the VST image may be used to segment the VST image into meaningful parts, for example, such as separating a wall from remaining objects in a portion of a room represented in the VST image. The semantic analysis may utilise deep learning models to identify and segment different objects represented in the VST image. When the activity analysis is used, the plurality of image segments are determined, based on moving/dynamic objects represented in the VST image. All the aforementioned analyses for performing a division of the VST image are well-known in the art. Alternatively, optionally, the at least one processor is configured to divide the VST image into a plurality of image segments, based on spatial geometries of the objects or their portions present in the real-world environment. Herein, the term “spatial geometry” relates to shapes and relative arrangements of the objects or their portions present in the real-world environment. Optionally, the at least one processor is configured to employ at least one computer vision algorithm, for processing the VST image to extract information pertaining to said spatial geometry therefrom. Such computer vision algorithms are well-known in the art.

It will be appreciated that since a location of a given image segment from amongst the plurality of image segments in the VST image and a location of the gaze region in the VST image are known (for example, using image coordinates), the image segment that lies at least partially within the gaze region could be easily and accurately determined by the at least one processor. It will also be appreciated that in some cases, the image segment lies partially within the gaze region, i.e., the image segment also extends beyond the gaze region. In such cases, the image segment may represent an object such that only a given part of the object lies within the gaze region, while a remaining part of the object lies outside (namely, extends beyond) the gaze region. In other cases, the image segment lies entirely within the gaze region, i.e., the image segment does not extend beyond the gaze region. In such cases, the image segment may represent an object such that an entirety of the object lies within the gaze region.

Notably, the gaze region includes the at least one object at which the user is looking. The term “object” refers to a physical object or a part of the physical object present in the real-world environment. An object could be a living object (for example, such as a human, a pet, a plant, and the like) or a non-living object (for example, such as a wall, a window, a toy, a poster, a lamp, and the like).

In some implementations, when identifying the at least one object, the at least one processor is configured to map the gaze direction onto the 3D model from a perspective of the camera pose, in order to ascertain a region in the real-world environment being represented in the VST image, and which object(s) in said region the user is looking (namely, gazing or focussing) at.

Throughout the present disclosure, the term “three-dimensional model” of the real-world environment refers to a data structure comprising comprehensive information pertaining to objects or their portions present in the real-world environment. Such comprehensive information is indicative of at least one of: surfaces of the objects or their portions, a plurality of features of the objects or their portions, shapes and sizes of the objects or their portions, poses of the objects or their portions, materials of the objects or their portions, colour information of the objects or their portions, depth information of the objects or their portions, light sources and lighting conditions within the real-world environment. Examples of the plurality of features include, but are not limited to, edges, corners, blobs, and ridges.

Optionally, the 3D model is in a form of at least one of: a 3D polygonal mesh, a 3D point cloud, a 3D surface cloud, a 3D surflet cloud, a voxel-based model, a parametric model, a 3D grid, a 3D hierarchical grid, a bounding volume hierarchy, an image-based 3D model. The 3D polygonal mesh could be a 3D triangular mesh or a 3D quadrilateral mesh. Optionally, the at least one processor is configured to obtain the 3D model from the data storage, wherein the 3D model is pre-generated (for example, by the at least one processor), and pre-stored at the data storage.

However, in other implementations, when identifying the at least one object, the at least one processor is configured to utilise a previous image that was displayed to the user. This is because a camera pose from a perspective of which a previous VST image (using which the previous image was generated) has been captured, would typically not change drastically when the VST image is captured. Thus, it may be highly likely that the at least one object that is represented in the VST image is also represented (at almost a same location) in the previous image. Therefore, the at least one object could be identified in this way, using the previous image.

Optionally, when identifying the at least one object, the at least one processor is configured to employ at least one object identification technique. The at least one object identification technique could, for example, be based on machine learning algorithms, deep learning algorithms, or similar. Object identification techniques are well-known in the art. It is to be understood that the at least one object identification technique could be employed in conjunction with any of the aforesaid two implementations. Moreover, object identification for identifying the at least one object could alternatively be performed by utilising the at least one neural network.

An image quality of the VST image is typically adversely affected due to several reasons, for example, such as variations in lighting conditions in the real-world environment, a movement of the camera that is capturing the VST image, a movement of an object (or its portion) being captured by the camera, a dis-occlusion of an object (or its portion) in the VST image upon reprojection, an autofocus blurring of a background or a foreground in the VST image, and the like. Thus, in such a case, it may be likely that at least the image segment in the VST image may have some defect (for example, such as a high noise, a motion blur, a defocus blur, a low brightness, and the like) and/or missing/obliterated visual information therein. Since the at least one object (or its part) would be perceived with a high visual acuity by a fovea of the user's eye, as compared to remaining, non-gaze-contingent object(s), the image segment of the VST image is synthetically generated in a manner that upon said generation, the image segment would have complete and considerably high visual detail. In other words, upon said generation of the image segment, the defect in the image segment and the missing/obliterated visual information in the image segment would be reconstructed (namely, restored or filled-in). The phrase “synthetically generate” means correction of the defect and/or generation the missing/obliterated visual information, in at least the image segment of the VST image, and optionally means modification of visual content represented in at least the image segment in other feasible ways, based on the at least one input (as discussed later in detail).

Optionally, the at least one neural network is a convolutional neural network (CNN), a U-net type neural network, an autoencoder, a Residual Neural Network (ResNet), a Vision Transformer (VIT), a neural network having self-attention layers, a Generative Adversarial Network (GAN), a deep unfolding-type (namely, deep unrolling-type) neural network, a stable diffusion neural network. The at least one neural network could be a diffusion model or a generative model. All the aforementioned types of neural networks are well-known in the art. It will be appreciated that two or more of the aforementioned types of analysis neural networks could also be employed in a parallel or a series combination.

Typically, the stable diffusion neural network is a type of a generative neural network that is designed to create high-quality images from text descriptions or to modify existing images through a process called “diffusion”. The stable diffusion neural network belongs to a family of diffusion-type neural networks which are a class of probabilistic models that iteratively transform noise into a coherent image by reversing a diffusion process. Herein, the diffusion process refers to a technique where a stable diffusion neural network learns to reverse a gradual corruption of data. Initially, an image is turned into noise by adding small perturbations. The stable diffusion neural network then learns to reverse this in a step-by-step manner, to reconstruct an original image or to generate a new image that matches a given text description (that is provided as an input to the stable diffusion neural network). The stable diffusion neural network can generate images from textual descriptions. Given a prompt, the stable diffusion neural network can create a corresponding image by iteratively refining a random noise into a coherent image that aligns with the given text description. Moreover, the stable diffusion neural network can also perform an inpainting operation, which involves filling-in missing or masked parts of an image. This is particularly useful in editing images, where part(s) of an image need to be replaced or modified while keeping a remainder of the image intact. Moreover, while the inpainting operation involves filling-in or modifying parts of the image within its existing boundaries, an outpainting operation refers to generating additional visual content that is actually outside the existing boundaries of the image (namely, generating visual content that is not even captured within a field of view of the image). In a context of the VST image, the stable diffusion neural network can also facilitate in generating new visual content that extends beyond edges of an original VST image. This may be useful when the original VST image needs to be expanded or if a field of view of the original VST image needs to be artificially (namely, synthetically) increased, by adding the new visual content outside its existing boundaries. Such an outpainting operation may involve generating the new visual content that is only partially outside a boundary of the original VST image, thereby effectively blending existing visual content in the original VST image with the (generated) new visual content. Furthermore, the stable diffusion neural network can generate images either unconditionally (starting from noise without any guidance) or conditionally (guided by text prompts or reference images).

Optionally, when synthetically generating at least the image segment, the at least one neural network performs at least one operation on at least the image segment, that provides a result that is similar to applying at least one image processing algorithm on at least the image segment. Examples of the at least one image processing algorithm include, but are not limited to, an inpainting algorithm, a defocus deblurring algorithm, a motion deblurring algorithm, a blur-addition algorithm, a denoising algorithm, a text enhancement algorithm, an edge enhancement algorithm, a contrast enhancement algorithm, a colour enhancement algorithm, a sharpening algorithm, a colour conversion algorithm, an high-dynamic range (HDR) algorithm, an object enhancement algorithm, a style transfer algorithm, an auto white-balancing algorithm, a low-light enhancement algorithm, a tone mapping algorithm, a distortion correction algorithm, an exposure correction algorithm, a saturation correction algorithm, and a super-resolution algorithm. All the aforementioned image processing algorithms are well-known in the art. Optionally, the at least one neural network is trained to synthetically generate at least one image segment in a given image from amongst a plurality of images, by using a set of pairs of ground-truth images and corresponding defective images. It is to be noted that the at least one neural network would be utilised for synthetically generating at least the image segment during an inference phase of the analysis neural network (namely, after a training phase of the at least one neural network, i.e., when the at least one neural network has been trained).

It will be appreciated that by performing the synthetic generation of at least the image segment in the aforesaid manner, defect-free, high-quality VST images are generated. Beneficially, in such a case, such VST images could be conveniently used to create extended-reality (XR) environments. This may also potentially improve image aesthetics, realism and immersiveness for users, within the XR environments. The method and the system are susceptible to employed for generating high visual quality images along with fulfilling other requirements in XR devices, for example, such as a high resolution (such as a resolution higher than or equal to 60 pixels per degree), a small pixel size, a large field of view, and a high frame rate (such as a frame rate higher than or equal to 90 FPS).

Optionally, the system further comprises an ambient light sensor and a colour temperature sensor for measuring a brightness and a colour temperature in the real-world environment, respectively, wherein the at least one processor is configured to utilise the at least one neural network for modifying a colour temperature and a brightness of at least the image segment in the VST image, based on the measured brightness and the measured colour temperature. Optionally, for this purpose, the at least one neural network comprises a stable diffusion neural network, which can be utilised as described earlier.

Optionally, the at least one input comprises information pertaining to a current state of the at least one object. The term “current state” of the at least one object refers to an attribute describing a present condition or a present operational status of the at least one object. In this regard, there may be a scenario where the current state of the at least one object is not clearly represented in the image segment. However, the current state of the at least one object could be pre-known to the at least one processor, and thus could be provided as the at least one input for synthetically generating at least the image segment accordingly. The current state could be pre-known to the at least one processor because information pertaining to object(s) present in an environment where the system is implemented, can be pre-known. The technical benefit of providing said information as the at least one input is that said information pertaining to the current state is served as a guide/reference to the at least one neural network, for synthetically generating at least the image segment in an accurate and contextually-appropriate manner. Such an approach enhances an ability of the at least one neural network to produce semantically-consistent and visually-plausible results. This may enhance an overall viewing experience of the user.

Optionally, the information pertaining to the current state of the at least one object is in a form of any one of: a text, a flag, a code. In an example, said information may be in the form of a text indicating a type of a defect (for example, such as a high noise and a defocus blur) that needs to be corrected in the image segment. In another example, said information may be in the form of a text indicating what exactly needs to be synthetically generated. For example, when a meter reading of an instrument (for example, such as an altitude indicator or a speedometer) that is represented in the image segment, is known to the at least one processor, but said meter reading appears to be unclear and blurred in the image segment, said meter reading (in form of a text) could be provided as the at least one input for synthetically generating the image segment accordingly. In yet another example, said information may be in the form of a flag indicating an ON state or an OFF state of an indicator in a control panel that is represented in the image segment. In still another example, said information may be in the form of a code indicating a text that needs to be synthetically generated, or indicating a state of an indicator in a control panel that is represented in the image segment. The flag could, for example, be indicated using a bit. The code could, for example, be indicated using a few bits.

Optionally, the method further comprises:
detecting when the at least one object at which the user is looking is at least one instrument; and
when it is detected that the at least one object at which the user is looking is at least one instrument,
   obtaining information indicative of a current reading of the at least one instrument; and
   generating the information pertaining to the current state of the at least one object, based on the current reading of the at least one instrument.

In this regard, there may be a scenario where the image segment represents the at least one instrument, but the current reading of the at least one instrument that is accurately known to the at least one processor, is not clearly represented in the image segment. In an example, the current reading of the at least one instrument may be a value being displayed/indicated by the at least one instrument or an operational status of the at least one instrument. Thus, in such a scenario, said information pertaining to the current state could be generated according to the current reading of the at least one instrument (as obtained by the at least one processor), and then could be provided as the at least one input for synthetically generating at least the image segment accordingly. Advantageously, upon said generation of the image segment, the current reading of the at least one instrument is well-represented in the image segment, which improves an overall viewing experience of the user when a given image (that is generated using the VST image) is displayed to the user. This may, particularly, be beneficial when presenting an XR flight simulation environment to the user, as the user could clearly view even very fine details of instruments arranged in a cockpit. Herein, the term “instrument” refers to a part of a control instrumentation that enables the user to monitor and/or control an operation of a given entity. The given entity could be a vehicle, a manufacturing plant, and the like. In an example implementation, the control instrumentation may be arranged in a car (for a driver of the car), an aircraft (for a pilot of the aircraft), and the like. In such an example implementation, the at least one instrument could, for example, be a speedometer, an altitude indicator, a fuel indicator, a heading indicator (namely, a direction indicator), a temperature indicator, an odometer, a pressure indicator, and the like. It will be appreciated that it could be easily known when the at least one object is the at least one instrument, when the at least one object is identified using the at least one object identification technique (as discussed earlier). Optionally, the at least one processor is communicably coupled to the at least one instrument.

Optionally, the at least one input comprises a shape indicating the at least one object,

wherein the step of identifying the at least one object comprises identifying an object category to which the at least one object belongs,
wherein the method further comprises selecting the shape based on the object category to which the at least one object belongs.

In this regard, the shape indicating the at least one object could be provided as the at least one input to the at least one neural network, for example, in form of a mask. The technical benefit of providing the shape as the at least one input is that the shape explicitly delineates an area of the image segment that needs to be synthetically generated. In other words, the shape of the at least one object not only facilitates the at least one neural network in ascertaining which part of the VST image is to be synthetically generated, but also in conforming to a specific outline or boundary of the at least one object when synthetically generating the image segment. Beneficially, providing the shape as the at least one input ensures that the at least one neural network would produce accurate and visually-coherent results, for example, by generating relevant visual content that fits precisely according to the shape indicating the at least one object, thereby adhering to an expected structure of the at least one object in the image segment and seamlessly blending with a remaining part of the VST image. Optionally, the shape is provided in a form of a digital map.

Optionally, the at least one processor is configured to utilise the at least one neural network for identifying the at least one object, wherein the at least one neural network is trained using images of a plurality of objects belonging to a plurality of object categories. Once the at least one neural network is trained, the at least one neural network could be easily used to classify the at least one object into a given object category from the plurality of object categories. The plurality of object categories may be pre-known (namely, provided as the at least one input) to the at least one neural network. The term “object category” refers to a group of objects that share similar characteristics, attributes, and/or functions. In an example, an object category ‘vehicle’ may comprise a car, a truck, an aircraft, a bicycle, and the like. In another example, an object category ‘electronics’ may comprise a smartphone, a laptop, a camera, a television, and the like. In yet another example, an object category ‘animal’ may comprise a dog, a cat, a bird, a horse, and the like. In still another example, an object category ‘food item’ may comprise a fruit, a bread, a cheese, a vegetable, and the like.

It will be appreciated that selecting the shape based on the object category may involve utilising a predefined shape that correspond to a specific object category to which the at least one object belongs. This serves as a guide for the at least one neural network when synthetically generating the image segment, thereby ensuring that newly-generated visual content adheres to an expected form and structure of the at least one object belonging to the specific object category (namely, ensuring newly-generated visual content is well-aligned with a natural form of the at least one). Advantageously, by selecting the shape based on the object category, it may be ensured that when the image segment is synthetically generated, missing areas of the image segment are filled-in and/or defects in the image segment are corrected, while preserving a visual coherence of the at least one object. This may enable in improving an overall viewing experience of the user when a given image (that is generated using the VST image) is displayed to the user.

Optionally, the step of identifying the at least one object further comprises identifying an orientation of the at least one object in the VST image, wherein the shape is selected further based on the orientation of the at least one object in the VST image. In this regard, depending on how the at least one object is oriented in the VST image, for example, such as whether a front, a back, or a side of the at least one object is visible in the VST image, the shape indicating the at least one object is selected by the at least one neural network. This is because the at least one object could have different shapes when viewed from different orientations (namely, different perspectives). However, this may not always be the case, for example, when the at least one object is circular in shape. The technical benefit of taking into account the orientation for selecting the shape is that it allows the at least one neural network to select a shape that most-closely matches with the orientation of the at least one object in the VST image. Due to this, the image segment would be synthetically generated in a highly accurate and realistic manner, as the shape indicating the at least one object would be accurate and precise.

It will be appreciated that for identifying the orientation of the at least one object in the VST image could be performed using a combination of image analysis techniques and machine learning. In this regard, the at least one processor can utilise the at least one neural network for detecting and extract features of the at least one object. Such features enable in determining a basic shape and structure of the at least one object. Then, the at least one neural network can be utilised for comparing the extracted features against a database of known orientations for similar objects, for identifying the orientation of the at least one object.

Optionally, the at least one input comprises a reference image of the at least one object,

wherein the step of identifying the at least one object comprises identifying an object category to which the at least one object belongs,
wherein the method further comprises selecting the reference image from amongst a plurality of reference images, based on the object category to which the at least one object belongs.

Herein, the term “reference image” of a given object refers to an image of an object that is closely similar to the given object, and is served as an exemplary visual guide (namely, a reference) for synthetically generating the image segment. The reference image can be understood to provide a comprehensive information pertaining to an expected appearance, an expected structure, and/or expected features of the at least one object, to the at least one neural network. The technical benefit of providing the reference image as the at least one input is that the reference image provides a clear and accurate representation of an expected appearance of the at least one object. This allows the at least one neural network to utilise the reference image as a guide, ensuring that the image segment would be synthetically generated in a highly accurate and realistic manner. In this regard, the at least one neural network is designed to enhance a specific and a limited scope of the image (namely, the image segment), when the reference image closely represents a same object at which the user is looking. Such an approach allows the at least one neural network to require less extensive training and fewer capabilities, resulting in faster training time and more efficient inference. Consequently, this would also facilitate in saving processing time of the at least one processor, and utilising minimal processing resources of the at least one processor. Beneficially, this may also subsequently improve an overall viewing experience of the user, when a given image (that is generated using the VST image) is displayed to the user. Optionally, the plurality of reference images are pre-stored at the data storage. Furthermore, the technical benefit of selecting the reference image based on the object category to which the at least one object belongs is that it ensures a reference image that is most relevant and contextually appropriate is selected and utilised for synthetically generating the image segment. By categorising a plurality of objects and associating them with the plurality of reference images, the at least one neural network could select a given reference image from amongst the plurality of reference images, that best matches a particular type of the at least one object being represented by the image segment. Moreover, selecting the reference image based on the object category may also improve an accuracy of performing a synthetic generation of the image segment, as an object represented in the (selected) reference image would have similar features and attributes as that of the at least one object represented in the VST image. Information pertaining to how the object category to which the at least one object belongs, is identified, has been already discussed earlier.

Optionally, the step of identifying the at least one object further comprises identifying an orientation of the at least one object in the VST image, wherein the reference image is selected further based on the orientation of the at least one object in the VST image. In this regard, depending on how the at least one object is oriented in the VST image, for example, such as whether a front, a back, or a side of the at least one object is visible in the VST image, the reference image is selected by the at least one neural network. This is because the at least one object could have different shapes when viewed from different orientations (namely, different perspectives), and thus there could be several different reference images representing a same object with several different orientations. The technical benefit of taking into account the orientation for selecting the reference image is that it allows the at least one neural network to select a given reference image representing an object having an orientation that most-closely matches with the orientation of the at least one object in the VST image. Due to this, the image segment would be synthetically generated in a highly accurate and realistic manner. Information pertaining to how the orientation of the at least one object is identified, has been already discussed earlier.

Optionally, the at least one input comprises a colour to be used during the step of synthetically generating the image segment,

wherein the step of identifying the at least one object comprises identifying an object category to which the at least one object belongs,
wherein the method further comprises selecting the colour to be used based on the object category to which the at least one object belongs.

In this regard, the colour that is to be utilised when synthetically generating the image segment, is provided as the at least one input to the at least one neural network. The technical benefit of providing the colour as the at least one input is that it ensures a consistency and accuracy in an appearance of the at least one object in the (synthetically-generated) image segment. This is because the at least one neural network could reconstruct the at least one object with correct hues and shades (as indicated by the colour), thereby closely matching expected visual characteristics of the at least one object. This may, particularly, be beneficial in providing a realism and an immersiveness to the user viewing the at least one object, as the colour is a prominent factor in visual perception. In this regard, the at least one neural network is designed to enhance a specific and a limited scope of the image (namely, the image segment), when the colour to be used during the step of synthetically generating closely matches with a colour of a same object at which the user is looking. Such an approach allows the at least one neural network to require less extensive training and fewer capabilities, resulting in faster training time and more efficient inference. Consequently, this would also facilitate in saving processing time of the at least one processor, and utilising minimal processing resources of the at least one processor. Using the colour to be used during the step of synthetically generating the image segment may also take into account a change in lighting conditions within the real-world environment, as said change in the lighting conditions may affect an actual colour of an object. Moreover, the technical benefit of selecting the colour based on the object category is that it aligns synthetic generation of the image segment with typical or expected colours for that particular object category. This facilitates in synthetically generating the image segment in a highly accurate and realistic manner. Different object categories may be pre-associated with typical, characteristic colours. By selecting a colour that is commonly associated with the object category to which the at least one object belongs, the at least one neural network can produce a believable and contextually-accurate image segment. It will be appreciated that when synthetically generating the image segment, a material of the at least one object (apart from its colour) is also taken into account by the at least one neural network.

Optionally, the method further comprises:
detecting, by utilising a depth image corresponding to the VST image, when a plurality of objects represented in the gaze region of the VST image are at different optical depths; and
when it is detected that the plurality of objects represented in the gaze region are at the different optical depths, determining at least one of the plurality of objects whose optical depth is different from a focus depth employed for capturing the VST image, wherein the image segment that lies at least partially within the gaze region of the VST image represents the at least one of the plurality of objects whose optical depth is different from the focus depth.

The term “depth image” refers to an image that is indicative of optical depths of the objects or their portions present in the real-world environment. Optionally, the depth image is in a form of a depth map. The term “depth map” refers to a data structure comprising information pertaining to the optical depths of the objects or their portions present in the real-world environment. The depth map could be an image comprising a plurality of pixels, wherein a pixel value of each pixel indicates an optical depth of its corresponding 3D point within a region of the real-world environment. Optionally, the depth image and the VST image are captured using a depth camera. It is to be noted that the depth image and the VST image are captured simultaneously (namely, contemporaneously). Examples of the depth camera have been already discussed earlier. It will be appreciated that the depth image could alternatively be generated, based on a stereo disparity between a stereo pair of images captured, for example, by a pair of visible-light cameras.

It will be appreciated that when the plurality of objects represented in the gaze region are at the different optical depths and the VST image is captured by employing the focus depth, the at least one of the plurality of objects whose optical depth is different from the focus depth would appear to be blurred (due to defocus) in the gaze region. On the other hand, a remainder of the plurality of objects whose optical depth is either same as the focus depth or lies within a depth-of-field of the camera at the focus depth, would appear to be in-focus (namely, sharp) in the VST image. Since optical depths of the plurality of objects are readily known from the depth image, the at least one processor could easily ascertain the at least one of the plurality of objects as well as the remainder of the plurality of objects.

Moreover, the at least one of the plurality of objects whose optical depth is different from the focus depth is same as the at least one object at which the user is looking. Optionally, in this regard, when synthetically generating the image segment representing the at least one of the plurality of objects, the at least one neural network is utilised for applying defocus deblurring in the image segment. Upon said generation, the at least one of the plurality of objects whose optical depth is different from the focus depth (namely, the at least one object at which the user is looking) is well-focussed/sharp (i.e., free from any defocus blur) in the gaze region of the VST image. This may improve an overall viewing experience of the user when a given image (that is generated using the VST image after synthetic generation of the image segment) is displayed to the user.

It will be appreciated that the focus depth employed for capturing the VST image could be adjusted by adjusting a focus range of the camera employed to capture the VST image. The focus range is a range of optical depths at which the camera focusses within the real-world environment. Optionally, the focus range of the camera is divided into a plurality of steps. In such a case, an optical focus of the camera is adjusted in a step-wise manner. Optionally, the plurality of steps lie in a range of 20 to 30. Optionally, the plurality of steps divide the focus range in a plurality of intervals, based on a depth-of-field at different optical depths. When a given step is employed for focussing the camera, its optical focus is adjusted to lie at a given optical depth. As a result, the camera well-focusses object(s) lying at the given optical depth, as well as object(s) lying within a depth-of-field about a focal length corresponding to the given optical depth.

Optionally, the method further comprises:
detecting whether a velocity of a camera employed to capture the VST image exceeded a predefined threshold velocity when capturing the VST image; and
performing the step of synthetically generating at least the image segment in the VST image, only when it is detected that the velocity of the camera exceeded the predefined threshold velocity when capturing the VST image.

In this regard, when the velocity of the camera exceeds the predefined threshold velocity when capturing the VST image, it means that the velocity of the camera is considerably high, and it may be highly likely that a motion blur has occurred in the VST image. Resultantly, the at least one object may appear to be blurred in the image segment (due to an apparent streaking of the at least one object, irrespective of whether the at least one object is moving or stationary in the real-world environment). When the camera that is employed to capture the VST image is mounted on an HMD device worn by the user, the motion blur could occur when a head of the user is moving or shaking. Optionally, in this regard, when synthetically generating the image segment, the at least one neural network is utilised for applying motion deblurring in the image segment. Upon said generation, the at least one object at which the user is looking appears to be well-focussed (i.e., free from any motion blur) in the gaze region of the VST image. This improves an overall viewing experience of the user when a given image (that is generated using the VST image after synthetic generation of the image segment) is displayed to the user. The velocity of the camera could, for example, be determined by employing an Inertial Measurement Unit (IMU), or by dividing a displacement of corresponding points between two consecutive VST images and by a time period between capturing the two consecutive VST images. Alternatively, the velocity of the camera could be determined by tracking a pose of the HMD device, as a movement of the camera is either identical to, or can be deduced from a movement of the HMD device to which the camera is fixed. Optionally, the predefined threshold velocity lies in a range of 0.1 degree per millisecond to 20 degrees per millisecond. Herein, “degree” refers to an angular distance by which the camera moves. In this regard, the velocity of the camera is expressed as an angular velocity of the camera.

Optionally, the method further comprises:
determining a difference between the VST image and a previous image that was displayed to the user;
determining at least one other image segment in the VST image, based on said difference; and
identifying at least one other object, based on at least one of: the camera pose, the 3D model, a location of the at least one other image segment in the VST image,
   wherein the step of synthetically generating further comprises synthetically generating the at least one other image segment in the VST image, based on the at least one other object, by utilising the at least one neural network, wherein at least one other input of the at least one neural network indicates the at least one other object.

In this regard, there may be a scenario where one or more object that is clearly (namely, sharply) represented in the previous image, is poorly captured (i.e., not well-represented) in the VST image. Since the (current) VST image and a previous VST image (that corresponds the previous image that was displayed to the user) are captured consecutively at a considerably high frame rate, it is likely that visual information of the real-world environment represented in both the (current) VST image and the previous VST image is significantly similar, as a change in a pose of the camera would be negligible (namely, insignificant). Thus, the difference between the VST image and the previous image enables in identifying the at least one other object that is represented by the at least one other image segment in the VST image, wherein the at least one other object is not well-captured in the VST image, but is clearly represented in the previous image. Optionally, when determining the difference between the VST image and the previous image, the at least one processor is configured to employ at least one of: an optical flow technique, a frame differencing technique, a background subtraction technique, a change detection algorithm, a motion detection algorithm, a histogram comparison technique, a template matching technique, an image subtraction technique, an edge detection and comparison technique, a feature matching technique (for example, such as a scale-invariant feature transform (SIFT) technique, a speeded-up robust features (SURF) technique, and the like), a deep learning-based change detection technique. All the aforesaid techniques/algorithms for determining differences between two images are well-known in the art. Once said difference is known, part(s) of the VST image where there is a change in the visual information could be known, for example, by creating a binary mask that highlights said part(s) of the VST image where significant changes have been detected. Thus, the at least one other image segment in the VST image could be easily identified by the at least one processor, for example, by way of utilising such a binary mask.

It will be appreciated that by mapping the location of the at least one other image segment in the VST image onto the 3D model, from a perspective of the camera pose, the at least one other object could be easily identified by the at least one processor. The location of the at least one other image segment in the VST image could, for example, be known by mapping a field of view of the VST image to a field of view of the camera employed to capture the VST image, and thus it could be identified which object the at least one other image segment is representing. Optionally, when identifying the at least one other object, the at least one processor is configured to employ the at least one object identification technique. It will also be appreciated that the at least one other image segment in the VST image is synthetically generated (by the at least one neural network) in a similar manner, as described earlier with respect to the at least one image segment of the VST image. Moreover, the at least one other input of the at least one neural network is implemented similarly to how the at least one input of the at least one neural network is implemented, as discussed earlier in detail. The technical benefit of synthetically generating the at least one other image segment in the VST image is that an overall image quality and an overall viewing experience of the user is improved by leveraging a fact that a visual scene typically does not change drastically across consecutive images when a sequence of images (that is generated corresponding to a sequence of VST images) is displayed to the user. This is because a given object that is displayed in the previous image (from amongst the consecutives images) would continue to be displayed in a current image to the user. In other words, the given object would not be missed/obliterated suddenly from the previous image to the current image.

Optionally, the method further comprises:
reprojecting the VST image from said camera pose to a head pose of the user;
detecting when at least one previously-occluded object is dis-occluded in at least one region in the VST image upon said reprojecting; and
when it is detected that at least one previously-occluded object is dis-occluded in at least one region in the VST image upon said reprojecting,
   identifying the at least one previously-occluded object that is dis-occluded, based on at least one of: the camera pose, the head pose, the 3D model, a location of the at least one region in the VST image, and
   wherein the step of synthetically generating further comprises synthetically generating the at least one region in the VST image, based on the at least one previously-occluded object, by utilising the at least one neural network, wherein at least one yet other input of the at least one neural network indicates the at least one previously-occluded object.

Optionally, when reprojecting the VST image from said camera pose to the head pose of the user, the least one processor is configured to employ at least one image reprojection algorithm. The at least one image reprojection algorithm comprises at least one space warping algorithm. Image reprojection algorithms are well-known in the art. The aforesaid reprojection is performed, for example, by utilising a depth image captured corresponding to the VST image. It will be appreciated that information pertaining to placements, geometries, occlusions, and the like, of objects or their portions in the depth image allows for accurately and realistically reprojecting the at VST image. It will also be appreciated that since a perspective of the camera employed to capture the VST image and a perspective of the head pose of the user are (slightly) different, and for synthetically generating the at least one region in the VST image, the at least one processor reprojects the VST image to match the perspective of the head pose of the user. Thus, the (reprojected) VST image represents visual information pertaining to a region of the real-world environment from the perspective of the head pose of the user. However, upon said reprojection, the at least one previously-occluded object is dis-occluded in the at least one region in the VST image. Since visual information pertaining to the at least one previously-occluded object is not captured (namely, unavailable) in the VST image, the at least one region in the VST image is represented as an empty/blank. The at least one region in the VST image may be highlighted using a specific colour, such as a black colour, a white colour, or similar, such that the at least one region in the VST image would be distinctly identifiable through said highlighting. It will be appreciated that the head pose of the user could be determined by processing pose-tracking data collected by the pose-tracking means that is employed to track a pose of the HMD device that is worn by the user on his/her head. The pose-tracking data may be in form of images, IMU/TIMU values, motion sensor data values, magnetic field strength values, or similar.

Since the at least one region in the VST image does not represent any visual information pertaining to the at least one previously-occluded object that has been dis-occluded, pixels in the at least one region are empty pixels, and could be easily identified in the VST image. Thus, the at least one previously-occluded object that is dis-occluded, is identified such that the at least one region in the VST image can be synthetically generated accordingly. It will be appreciated that by mapping the location of the at least one region in the VST image onto the 3D model, from a perspective of the camera pose, the at least one previously-occluded object that is dis-occluded could be easily identified by the at least one processor. The location of the at least one region in the VST image could, for example, be known by mapping a field of view of the VST image to a field of view of the camera employed to capture the VST image, and thus it could be identified which object has been dis-occluded in at least one region in the VST image. Optionally, when identifying the at least one previously-occluded object, the at least one processor is configured to employ the at least one object identification technique.

It will also be appreciated that the at least one region the VST image is synthetically generated (by the at least one neural network) in a similar manner, as described earlier with respect to the at least one image segment of the VST image. Moreover, the at least one yet other input of the at least one neural network is implemented similarly to how the at least one input of the at least one neural network is implemented, as discussed earlier in detail. The technical benefit of synthetically generating the at least one region in the VST image is that an overall viewing experience of the user is improved when a given image (that is generated using the VST image) is displayed to the user, because upon reprojection, the VST image would not have any missing/non-captured visual information therein.

There will now be discussed an exemplary use case of implementing the aforementioned computer-implemented method in a flight simulation environment. Herein, a user may be sitting in a cockpit, and may be moving his/her head to view a meter reading (for example, such as an altitude) in an altitude meter arranged in the cockpit. Pose-tracking means may be arranged in an HMD device being worn by the user. The pose-tracking means detect a medium-range motion when the user moved his/her head to view the meter reading. The user's gaze is directed towards the altitude meter. In such a case, the at least one neural network is utilised to synthetically generate the image segment representing the meter reading of the altitude meter in a manner that the meter reading accurately displays a text “Altitude is 1000 meters” in the image segment. Herein, the at least one input of the at least one neural network may comprise a reference image of the altitude meter and a shape of the altitude meter. Similarly, a broken pilot training platform could be fixed by inpainting a broken part of the cockpit. In another case, when the user's gaze is directed towards a display device (for example, such as a tablet, a smartphone, or similar) mounted on a kneeboard (or similar), the at least one neural network is utilised to synthetically generate another image segment representing a visual content displayed on the display device, such that upon such synthetic generation the visual content appears to be in focus. This can be done by leveraging a fact that the kneeboard (and hence, the display device) is at a known distance from the head of the user. For example, when the HMD device being worn by the user has a fixed-focus camera whose focus depth is 0.9 meters, objects present at different optical distances than said focus depth, for example, such as the kneeboard (and hence, the display device) being present at an optical distance of, for example, 0.5 meters, may appear to be blurred to the user. This is because the optical distance of 0.5 meters lies outside a depth-of-field of the fixed-focus camera whose focus depth is 0.9 metre. In such a scenario, the at least one neural network is be utilised to synthetically generate the another image segment such that the focus depth for the another image segment is adjusted to 0.4 meters (or to 0.5 meters directly), thereby effectively correcting a defocus blur in the another image segment. Resultantly, the visual content displayed on the display device appears to be in focus.

The present disclosure also relates to the system as described above. Various embodiments and variants disclosed above, with respect to the aforementioned first aspect, apply mutatis mutandis to the system.

Optionally, in the system, wherein the at least one input comprises information pertaining to a current state of the at least one object.

Optionally, the at least one processor is further configured to:
detect when the at least one object at which the user is looking is at least one instrument; and
when it is detected that the at least one object at which the user is looking is at least one instrument,
   obtain information indicative of a current reading of the at least one instrument; and
   generate the information pertaining to the current state of the at least one object, based on the current reading of the at least one instrument.

Optionally, the at least one input comprises a shape indicating the at least one object,

wherein when identifying the at least one object, the at least one processor is further configured to identify an object category to which the at least one object belongs,
wherein the at least one processor is further configured to select the shape based on the object category to which the at least one object belongs.

Optionally, when identifying the at least one object, the at least one processor is further configured to identify an orientation of the at least one object in the VST image, wherein the shape is selected further based on the orientation of the at least one object in the VST image.

Optionally, the at least one input comprises a reference image of the at least one object,

wherein when identifying the at least one object, the at least one processor is further configured to identify an object category to which the at least one object belongs,
wherein the at least one processor is further configured to select the reference image from amongst a plurality of reference images, based on the object category to which the at least one object belongs.

Optionally, when identifying the at least one object, the at least one processor is further configured to identify an orientation of the at least one object in the VST image, wherein the reference image is selected further based on the orientation of the at least one object in the VST image.

Optionally, the at least one input comprises a colour to be used when synthetically generating the image segment,

wherein when identifying the at least one object, the at least one processor is further configured to identify an object category to which the at least one object belongs,
wherein the at least one processor is further configured to select the colour to be used based on the object category to which the at least one object belongs.

Optionally, the at least one processor is further configured to:
detect, by utilising a depth image corresponding to the VST image, when a plurality of objects represented in the gaze region of the VST image are at different optical depths; and
when it is detected that the plurality of objects represented in the gaze region are at the different optical depths, determine at least one of the plurality of objects whose optical depth is different from a focus depth employed for capturing the VST image, wherein the image segment that lies at least partially within the gaze region of the VST image represents the at least one of the plurality of objects whose optical depth is different from the focus depth.

Optionally, the at least one processor is further configured to:
detect whether a velocity of a camera employed to capture the VST image exceeded a predefined threshold velocity when capturing the VST image; and
synthetically generate at least the image segment in the VST image, only when it is detected that the velocity of the camera exceeded the predefined threshold velocity when capturing the VST image.

Optionally, the at least one processor is further configured to:
determine a difference between the VST image and a previous image that was displayed to the user;
determine at least one other image segment in the VST image, based on said difference; and
identify at least one other object, based on at least one of: the camera pose, the 3D model, a location of the at least one other image segment in the VST image,
   wherein when synthetically generating at least the image segment in the VST image, the at least one processor is further configured to synthetically generate the at least one other image segment in the VST image, based on the at least one other object, by utilising the at least one neural network, wherein at least one other input of the at least one neural network indicates the at least one other object.

Optionally, the at least one processor is further configured to:
reproject the VST image from said camera pose to a head pose of the user;
detect when at least one previously-occluded object is dis-occluded in at least one region in the VST image upon said reprojecting; and
when it is detected that at least one previously-occluded object is dis-occluded in at least one region in the VST image upon said reprojecting,
   identify the at least one previously-occluded object that is dis-occluded, based on at least one of: the camera pose, the head pose, the 3D model, a location of the at least one region in the VST image, and
      wherein when synthetically generating at least the image segment in the VST image, the at least one processor is further configured to synthetically generate the at least one region in the VST image, based on the at least one previously-occluded object, by utilising the at least one neural network, wherein at least one yet other input of the at least one neural network indicates the at least one previously-occluded object.

### DETAILED DESCRIPTION OF THE DRAWINGS

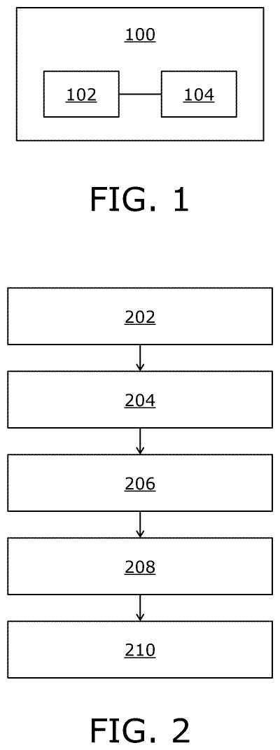

Referring to FIG. 1, illustrated is a block diagram of an architecture of a system 100 incorporating guided in-painting, in accordance with an embodiment of the present disclosure. The system 100 comprises a data storage 102 and at least one processor (for example, depicted as a processor 104). The processor 104 is communicably coupled to the data storage 102. The processor 104 is configured to perform various operations, as described earlier with respect to the aforementioned second aspect.

It may be understood by a person skilled in the art that the FIG. 1 includes a simplified architecture of the system 100 for sake of clarity, which should not unduly limit the scope of the claims herein. It is to be understood that the specific implementation of the system 100 is provided as an example, and is not to be construed as limiting it to specific numbers and types of data storages and processors. The person skilled in the art will recognize many variations, alternatives, and modifications of embodiments of the present disclosure.

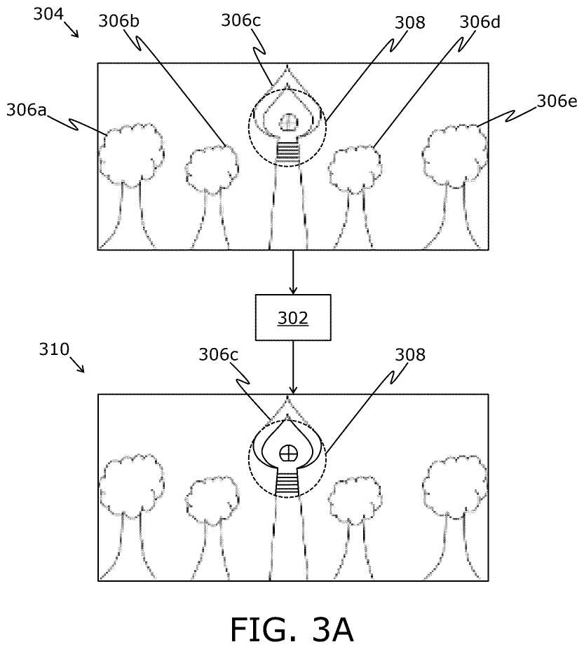

Referring to FIG. 2, illustrates are steps of a method incorporating guided in-painting, in accordance with an embodiment of the present disclosure. At step 202, information indicative of a gaze direction is obtained. At step 204, a gaze region of a video-see-through (VST) image of a real-world environment is determined, based on the gaze direction. At step 206, an image segment is determined in the VST image, wherein the image segment lies at least partially within the gaze region of the VST image. At step 208, at least one object at which the user is looking is identified, based on the gaze direction, and optionally at least one of: a camera pose from which the VST image is captured, a three-dimensional (3D) model of the real-world environment. At step 210, at least the image segment in the VST image is synthetically generated, based on the at least one object at which the user is looking, by utilising at least one neural network, wherein at least one input of the at least one neural network indicates the at least one object.

The aforementioned steps of the method are only illustrative and other alternatives can also be provided where one or more steps are added, one or more steps are removed, or one or more steps are provided in a different sequence without departing from the scope of the claims herein. It will be appreciated that the method is easy to implement and provides the simple implementation.

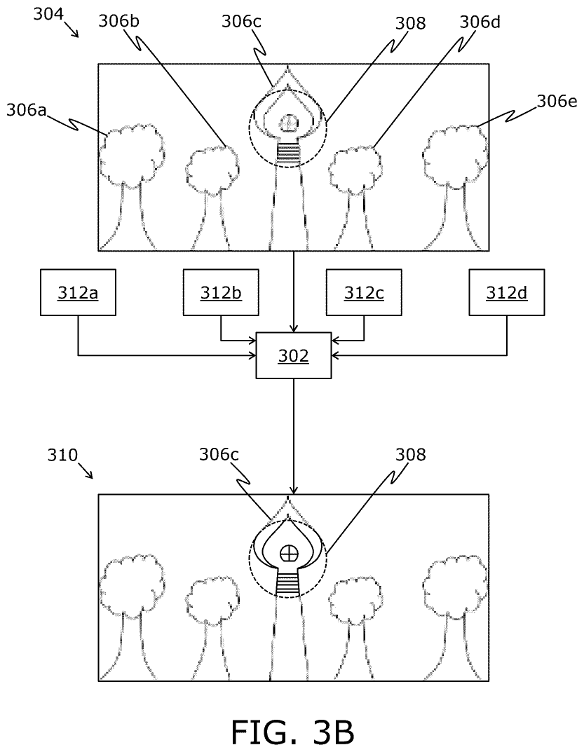

Referring to FIGS. 3A and 3B, illustrated are different exemplary scenarios of utilising at least one neural network (for example, depicted as a neural network 302) for synthetically generating an image segment of a video-see-through (VST) image 304 of a real-world environment, in accordance with different embodiments of the present disclosure. With reference to FIGS. 3A and 3B, the image segment of the VST image 304 of the real-world environment is shown to comprise a plurality of objects 306a, 306b, 306c, 306d, and 306e, wherein the plurality of objects 306a-e appear to be blurred (namely, out-of-focus) in the VST image 304. The image segment of the VST image 304 lies within a gaze region 308 (depicted using a dashed circle) of the VST image 304, wherein the gaze region 308 represents a portion of the object 306c at which a user is looking. For sake of simplicity and convenience only, a size and/or a shape of the image segment in the VST image 304 is shown to be exactly same as a size and/or a shape of the gaze region 308. The neural network 302 is utilised for synthetically generating the image segment of the VST image 304, based on said portion of the object 306c at which the user is looking, wherein an input of the at least one neural network 302 indicates said portion of the object 306c. An output of the neural network 302 comprises an output VST image 310, wherein said output VST image 310 is generated upon synthetically generating the image segment of the VST image 304, wherein said portion of the object 306c in the output VST image 310 appears to be in-focus (namely, clearly visible and sharp), wherein said portion of the object 306c corresponds to the gaze region 308. Optionally, the output VST image 310 is utilised for generating an extended-reality (XR) image that is to be displayed to the user.

With reference to FIG. 3B, the input of the at least one neural network 302 at least one of: (i) information pertaining to a current state 312a of the object 306c, (ii) information pertaining to a shape 312b indicating the object 306c, (iii) a reference image 312c of the object 306c, (iv) information pertaining to a colour 312d to be used during synthetically generating the image segment.

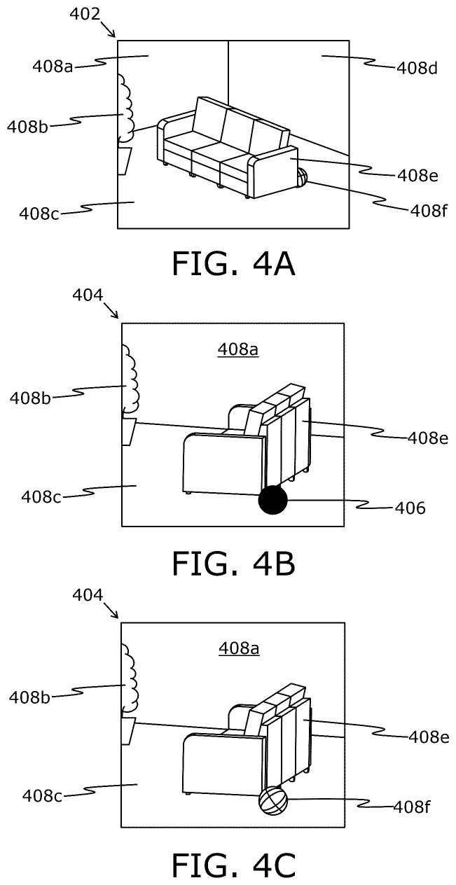

Referring to FIGS. 4A, 4B, and 4C, FIG. 4A illustrates an exemplary video-see-through (VST) image 402 of a real-world environment, FIG. 4B illustrates an exemplary reprojected VST image 404 of the real-world environment, while FIG. 4C illustrates the reprojected VST image 404 upon synthetically generating a region 406 as shown in FIG. 4B, in accordance with an embodiment of the present disclosure. With reference to FIG. 4A, the VST image 402 is shown to represent a living room in the real-world environment, the living room comprising a plurality of objects 408a, 408b, 408c, 408d, 408e, and 408f, depicted as a first wall, an indoor plant, a floor, a second wall, a couch, and a ball, respectively. The VST image 402 represents a view of the living room from a perspective of a camera pose of a camera employed to capture the VST image 402. It can be observed that from the perspective of the camera pose, the object 408f (namely, the ball) is partially occluded by the object 408e (namely, the couch) in the VST image 402. In other words, in FIG. 4A, only a portion of the object 408f that is visible from said perspective of the camera pose, is represented in the VST image 402.

With reference to FIG. 4B, the reprojected VST image 404 is obtained upon reprojecting the VST image 402 (as shown in FIG. 4b) from said camera pose to a head pose of a user. The reprojected VST image 404 represents a reprojected view of the (same) living room from a perspective of a the head pose of the user. It can be observed that from the perspective of the head pose of the user, the object 408f (namely, the ball) that was previously-partially occluded by the object 408e (namely, the couch) is dis-occluded in the region 406 of the reprojected VST image 404. Since visual information (for example, comprising colour information, depth information, and the like) of the region 406 is unavailable/missing (upon reprojecting the VST image 402), the region 406 is highlighted using a black colour in FIG. 4B. In this regard, in order to generate the visual information of the region 406, the region 406 is synthetically generated, based on the object 408f, by utilising at least one neural network (not shown), wherein an input of the at least one neural network indicates the object 408f. In an example implementation, said input may comprise a shape indicating the object 408f, wherein said shape is provided in a form of a mask. With reference to FIG. 4C, upon synthetically generating the region 406 in the reprojected VST image 404 (as shown in FIG. 4B), visual information pertaining to an entirety of the object 408f is now available/visible in the reprojected VST image 404.

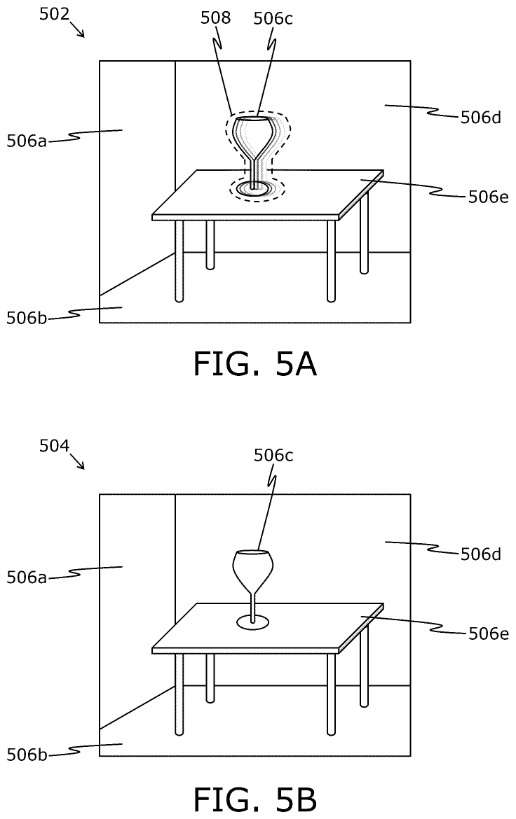

Referring to FIGS. 5A and 5B, FIG. 5A illustrates an exemplary video-see-through (VST) image 502 of a real-world environment, while FIG. 5B illustrates an exemplary previous image 504 of the real-world environment that was displayed to a user, in accordance with an embodiment of the present disclosure. With reference to FIGS. 5A and 5B, the VST image 502 and the previous image 504, respectively, are shown to represent a dining room in the real-world environment, the dining room comprising a plurality of objects 506a, 506b, 506c, 506d, and 506e, depicted as a first wall, a floor, a wine glass, and a table, respectively. With reference to FIG. 5A, as shown, one of the plurality of objects (namely, the object 506c i.e., the wine glass) is captured with a motion blur which may have occurred, for example, due to a sudden jerk/shaking of a camera employed to capture the VST image 502. A remainder of the plurality of objects (namely, the objects 506a, 506b, 506d, and 506e) are well-captured in the VST image 502. On the other hand, with reference to FIG. 5B, as shown, the plurality of objects 506a-e are well-captured (namely, clearly and sharply captured) in the previous image 504. In this regard, with reference to FIGS. 5A and 5B, an image segment 508 (depicted using a dashed line shape) in the VST image 502 is determined by at least one processor, based on a difference between the VST image 502 and the previous image 504. Thereafter, the at least one processor is configured to utilise at least one neural network for synthetically generating the image segment 508, based on the object 506c of FIG. 5B, wherein an input of the at least one neural network indicates the object 506c of FIG. 5B. The object 506c of the FIG. 5B is used in said synthetic generation because it is well-captured in the previous image 504, and thus could be utilised as a reference for the at least one neural network. When synthetically generating the image segment 508, the at least one neural network applies motion deblurring on the image segment 508. For sake of simplicity, a new image generated after performing said synthetic generation of the image segment 508 (namely, after applying the motion deblurring) is not shown.

FIGS. 3A, 3B, 4A, 4B, 4C, 5A, and 5B are merely examples, which should not unduly limit the scope of the claims herein. A person skilled in the art will recognize many variations, alternatives, and modifications of embodiments of the present disclosure.

1. A computer-implemented method comprising:
obtaining information indicative of a gaze direction;
determining a gaze region of a video-see-through (VST) image of a real-world environment, based on the gaze direction;
determining an image segment in the VST image that lies at least partially within the gaze region of the VST image;
identifying at least one object at which a user is looking, based on the gaze direction, and optionally at least one of: a camera pose from which the VST image is captured, a three-dimensional (3D) model of the real-world environment; and
synthetically generating at least the image segment in the VST image, based on the at least one object at which the user is looking, by utilising at least one neural network, wherein at least one input of the at least one neural network indicates the at least one object.

2. The computer-implemented method of claim 1, wherein the at least one input comprises information pertaining to a current state of the at least one object.

3. The computer-implemented method of claim 2, wherein the method further comprises:
detecting when the at least one object at which the user is looking is at least one instrument; and
when it is detected that the at least one object at which the user is looking is at least one instrument,
obtaining information indicative of a current reading of the at least one instrument; and
generating the information pertaining to the current state of the at least one object, based on the current reading of the at least one instrument.

4. The computer-implemented method of claim 1, wherein the at least one input comprises a shape indicating the at least one object,
wherein the step of identifying the at least one object comprises identifying an object category to which the at least one object belongs,
wherein the method further comprises selecting the shape based on the object category to which the at least one object belongs.

5. The computer-implemented method of claim 4, wherein the step of identifying the at least one object further comprises identifying an orientation of the at least one object in the VST image, wherein the shape is selected further based on the orientation of the at least one object in the VST image.

6. The computer-implemented method of claim 1, wherein the at least one input comprises a reference image of the at least one object,
wherein the step of identifying the at least one object comprises identifying an object category to which the at least one object belongs,
wherein the method further comprises selecting the reference image from amongst a plurality of reference images, based on the object category to which the at least one object belongs.

7. The computer-implemented method of claim 6, wherein the step of identifying the at least one object further comprises identifying an orientation of the at least one object in the VST image, wherein the reference image is selected further based on the orientation of the at least one object in the VST image.

8. The computer-implemented method of claim 1, wherein the at least one input comprises a colour to be used during the step of synthetically generating the image segment,
wherein the step of identifying the at least one object comprises identifying an object category to which the at least one object belongs,
wherein the method further comprises selecting the colour to be used based on the object category to which the at least one object belongs.

9. The computer-implemented method of claim 1, further comprising:
detecting, by utilising a depth image corresponding to the VST image, when a plurality of objects represented in the gaze region of the VST image are at different optical depths; and
when it is detected that the plurality of objects represented in the gaze region are at the different optical depths, determining at least one of the plurality of objects whose optical depth is different from a focus depth employed for capturing the VST image, wherein the image segment that lies at least partially within the gaze region of the VST image represents the at least one of the plurality of objects whose optical depth is different from the focus depth.

10. The computer-implemented method of claim 1, further comprising:
detecting whether a velocity of a camera employed to capture the VST image exceeded a predefined threshold velocity when capturing the VST image; and
performing the step of synthetically generating at least the image segment in the VST image, only when it is detected that the velocity of the camera exceeded the predefined threshold velocity when capturing the VST image.

11. The computer-implemented method of claim 1, further comprising:
determining a difference between the VST image and a previous image that was displayed to the user;
determining at least one other image segment in the VST image, based on said difference; and
identifying at least one other object, based on at least one of: the camera pose, the 3D model, a location of the at least one other image segment in the VST image,
wherein the step of synthetically generating further comprises synthetically generating the at least one other image segment in the VST image, based on the at least one other object, by utilising the at least one neural network, wherein at least one other input of the at least one neural network indicates the at least one other object.

12. The computer-implemented method of claim 1, further comprising:
reprojecting the VST image from said camera pose to a head pose of the user;
detecting when at least one previously-occluded object is dis-occluded in at least one region in the VST image upon said reprojecting; and
when it is detected that at least one previously-occluded object is dis-occluded in at least one region in the VST image upon said reprojecting,
identifying the at least one previously-occluded object that is dis-occluded, based on at least one of: the camera pose, the head pose, the 3D model, a location of the at least one region in the VST image, and
wherein the step of synthetically generating further comprises synthetically generating the at least one region in the VST image, based on the at least one previously-occluded object, by utilising the at least one neural network, wherein at least one yet other input of the at least one neural network indicates the at least one previously-occluded object.

13. A system comprising:
a data storage for storing at least one neural network; and
at least one processor configured to:
obtain information indicative of a gaze direction;
determine a gaze region of a video-see-through (VST) image of a real-world environment, based on the gaze direction;
determine an image segment in the VST image that lies at least partially within the gaze region of the VST image;
identify at least one object at which a user is looking, based on the gaze direction, and optionally at least one of: a camera pose from which the VST image is captured, a three-dimensional (3D) model of the real-world environment; and
synthetically generate at least the image segment in the VST image, based on the at least one object at which the user is looking, by utilising the at least one neural network, wherein at least one input of the at least one neural network indicates the at least one object.

14. The system of claim 13, wherein the at least one input comprises information pertaining to a current state of the at least one object.

15. The system of claim 14, wherein the at least one processor is further configured to:
detect when the at least one object at which the user is looking is at least one instrument; and
when it is detected that the at least one object at which the user is looking is at least one instrument,
obtain information indicative of a current reading of the at least one instrument; and
generate the information pertaining to the current state of the at least one object, based on the current reading of the at least one instrument.
